(19) United States
(12) Patent Application Publication
(10) Pub. No.: US 2019/0278791 A1
(43) Pub. Date: Sep. 12, 2019

(54) NON-TRANSITORY COMPUTER READABLE RECORDING MEDIUM, METHOD FOR GENERATING, INFORMATION PROCESSING DEVICE, AND INFORMATION PROCESSING SYSTEM

(71) Applicant: FUJITSU LIMITED, Kawasaki-shi (JP)

(72) Inventors: Masahiro Kataoka, Kamakura (JP); Satoshi Onoue, Yokohama (JP); Ryo Matsumura, Numazu (JP)

(73) Assignee: FUJITSU LIMITED, Kawasaki-shi (JP)

(21) Appl. No.: 16/284,281

(22) Filed: Feb. 25, 2019

(30) Foreign Application Priority Data
Mar. 12, 2018 (JP) 2018-044476

(51) Int. Cl. G06F 16/31; G06F 17/27; G06F 16/33

(52) U.S. Cl. CPC G06F 16/316; G06F 16/3347; G06F 17/2785

(57) ABSTRACT

An information processing device receives a plurality of pieces of code information corresponding to a plurality of words included in text data, and specifies a plurality of pieces of code information the appearance frequency of which exceeds a reference among the pieces of code information being received, based on the pieces of code information. The information processing device acquires a plurality of vectors associated with the pieces of code information being specified, by referring to a storage that stores therein a vector corresponding to a word in association with code information corresponding to the word, and generates a representative vector representing the vectors.

### CROSS-REFERENCE TO RELATED APPLICATION(S)

This application is based upon and claims the benefit of priority of the prior Japanese Patent Application No. 2018-044476, filed on Mar. 12, 2018, the entire contents of which are incorporated herein by reference.

### FIELD

The embodiment discussed herein is related to a computer-readable recording medium and the like.

### BACKGROUND

In recent years, the technology of Word2Vec is used to generate vectors from text data, on the basis of morphemes that form text data to be analyzed. For example, in the technology of Word2Vec, a process of calculating a vector for each word is performed on the basis of a relation between a certain word (morpheme) and another word adjacent to the certain word.

Moreover, there is a conventional technology with which a vector table is used to specify a vector for each word, to sum up vector values of a sentence in text data. FIG. 11 is a diagram for explaining a conventional technology. In the conventional technology illustrated in FIG. 11, vector data 1b is generated by summing up the vectors of words, on the basis of sentence data 1a.

For example, words that form the sentence data 1a “He likes sweet apple.” are (He) (likes) (sweet) and (apple). In the conventional technology, the vectors of words are specified using a hash filter 2 and a vector table 3. The hash filter 2 is information that associates a hash value of a word with a pointer to the vector table 3. The vector table 3 is a table that stores therein vectors corresponding to words.

For example, when a hash value of the word “apple” is supplied to the hash filter 2, the position in the vector table 3 that stores therein the vector corresponding to the word “apple” is specified. For the sake of simple understanding, the vector of the word “apple” is represented as “vec (apple)”. In the conventional technology, each of the words “He, likes, sweet, and apple” included in the sentence data 1a is extracted by performing morphological analysis on the sentence data 1a. Then, the vector data 1b is generated by summing up the vectors of the words using the hash filter 2 and the vector table 3. See Japanese Laid-open Patent Publication No. 2010-198106, Japanese Laid-open Patent Publication No. 2009-223801, and Japanese Laid-open Patent Publication No. 2009-086202, for example.

### SUMMARY

According to an aspect of an embodiment, a non-transitory computer readable recording medium has stored therein a program that causes a computer to execute a process including: receiving a plurality of pieces of code information corresponding to a plurality of words included in text data; specifying a plurality of pieces of code information, an appearance frequency of which exceeds a reference among the pieces of code information being received, based on the pieces of code information; acquiring a plurality of vectors associated with the pieces of code information being specified, by referring to a storage that stores therein a vector corresponding to a word in association with code information corresponding to the word; and generating a representative vector representing the vectors being acquired, based on the vectors.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram for explaining an example of processing performed by an information processing device according to the present embodiment;

FIG. 2 is a functional block diagram illustrating a configuration of the information processing device according to the present embodiment;

FIG. 3 is a diagram for explaining processing performed by a code conversion unit;

FIG. 4 is a functional block diagram illustrating a configuration of a first operation unit according to the present embodiment;

FIG. 5 is a diagram illustrating an example of a data configuration of a vector table of the first operation unit;

FIG. 6 is a functional block diagram illustrating a configuration of a second operation unit according to the present embodiment;

FIG. 7 is a diagram illustrating an example of a data configuration of a vector table of the second operation unit;

FIG. 8 is a flowchart illustrating a processing procedure of the first operation unit according to the present embodiment;

FIG. 9 is a flowchart illustrating a processing procedure of the second operation unit according to the present embodiment;

FIG. 10 is a diagram illustrating an example of a hardware configuration of a computer that implements the same functions as those of the information processing device; and

FIG. 11 is a diagram for explaining a conventional technology.

### DESCRIPTION OF EMBODIMENT(S)

However, in the conventional technology described above, it is not possible to suppress the memory capacity needed for summing up the vectors of the words and generating vector data.

For example, in the vector table used in the conventional technology, the data amount of the table is 400 MB and large, relative to a half million words per language. Consequently, the memory capacity of a small-scale computer is stressed, thereby interfering with the execution of a computer program. Moreover, depending on the situation, it is sometimes difficult to store the vector table in memory.

Preferred embodiments of the present invention will be explained with reference to accompanying drawings. It is to be understood that the invention is not limited to the embodiment.

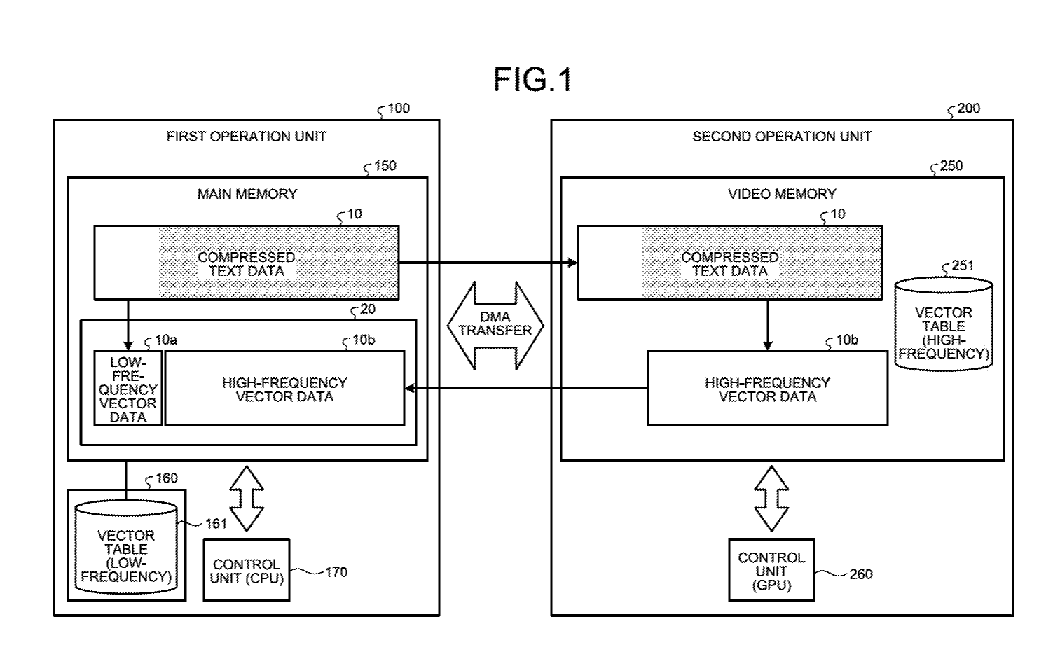

FIG. 1 is a diagram for explaining an example of processing performed by an information processing device according to the present embodiment. As illustrated in FIG. 1, the information processing device (information processing system) includes a first operation unit 100 and a second operation unit 200. For example, the first operation unit 100 corresponds to a personal computer (PC) and the like, and the second operation unit 200 corresponds to a graphics card and the like connected to the PC. The first operation unit 100 is an example of a first operation device. The second operation unit 200 is an example of a second operation device.

The first operation unit 100 includes a main memory 150, an auxiliary storage unit 160, and a control unit 170. For example, the auxiliary storage unit 160 includes a vector table 161. The vector table 161 is a table that associates a low-frequency word code with a vector. The control unit 170 is a control device corresponding to a central processing unit (CPU).

Upon receiving compressed text data 10, the control unit 170 stores the compressed text data 10 in the main memory 150. The compressed text data 10 is data in which text data is coded (compressed). For example, the compressed text data 10 includes a plurality of coded words. In the following explanation, the coded word is suitably referred to as a “word code”. The compressed text data 10 stored in the main memory 150 is transferred to the second operation unit 200 by direct memory access (DMA).

The control unit 170 sequentially reads out a part of data in the vector table 161 to the main memory 150, and compares the compressed text data 10 with the vector table 161. The control unit 170 then generates low-frequency vector data 10a by specifying vectors of low-frequency word codes, among the word codes included in the compressed text data 10.

The control unit 170 acquires high-frequency vector data 10b transmitted from the second operation unit 200, and generates vector data 20 corresponding to the compressed text data 10 by combining the low-frequency vector data 10a and the high-frequency vector data 10b.

The second operation unit 200 includes a video memory 250 and a control unit 260. For example, the control unit 260 is a control device corresponding to a graphics processing unit (GPU). The video memory 250 includes a vector table 251. The vector table 251 is a table that associates a high-frequency word code with a vector.

When the compressed text data 10 is stored in the video memory 250 by DMA transfer, the control unit 260 compares the compressed text data 10 with the vector table 251. The control unit 260 then generates the high-frequency vector data 10b by specifying vectors of the high-frequency word codes, among the word codes included in the compressed text data 10. The high-frequency vector data 10b is transferred to the first operation unit 100 by DMA.

As described above, the vector table 251 resides in the second operation unit 200. The second operation unit 200 generates the high-frequency vector data 10b corresponding to the high-frequency word codes, among the word codes included in the compressed text data 10, and transfers the high-frequency vector data 10b to the first operation unit 100.

Meanwhile, the first operation unit 100 sequentially reads out a part of data in the vector table 161, and generates the low-frequency vector data 10a corresponding to the low-frequency word codes. The first operation unit 100 generates the vector data 20 of the compressed text data 10, by combining the low-frequency vector data 10a generated by the first operation unit 100 and the high-frequency vector data 10b generated by the second operation unit 200.

The first operation unit 100 reads out a part of the vector table 161 to the main memory 150, and generates the low-frequency vector data 10a of the low-frequency word codes. By requesting the second operation unit 200 to generate the high-frequency vector data 10b of the high-frequency word codes, the first operation unit 100 can suppress the memory capacity needed for generating the vectors of the words.

Moreover, in the second operation unit 200, the vector table 251 is made to reside in the video memory 250. Consequently, compared to when data in the vector table 251 is sequentially read out from an auxiliary storage device, it is possible to accelerate the process of generating the high-frequency vector data 10b of the high-frequency word codes.

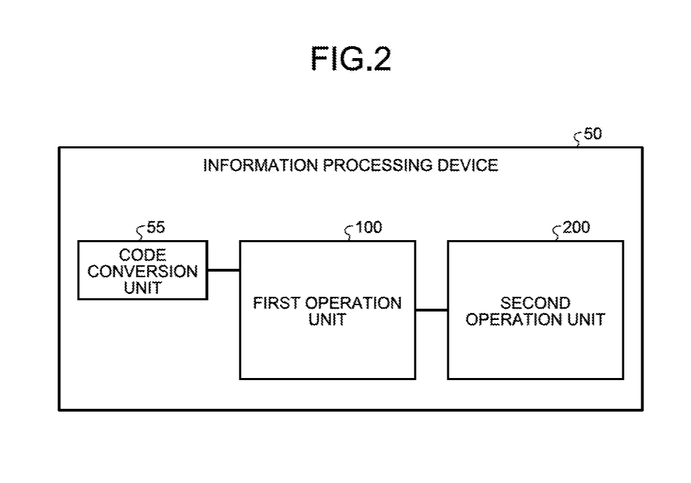

Next, an example of a configuration of the information processing device according to the present embodiment will be described. FIG. 2 is a functional block diagram illustrating a configuration of the information processing device according to the present embodiment. As illustrated in FIG. 2, an information processing device 50 includes a code conversion unit 55, the first operation unit 100, and the second operation unit 200.

The code conversion unit 55 is a processing unit that converts text data to the compressed text data 10. The code conversion unit 55 outputs the compressed text data to the first operation unit 100. For example, in FIG. 2, the code conversion unit 55 is provided outside of the first operation unit 100. However, it is not limited thereto. The code conversion unit 55 may also be provided inside of the first operation unit 100. Alternatively, functions corresponding to the code conversion unit 55 may be provided in an external device connected to the information processing device 50.

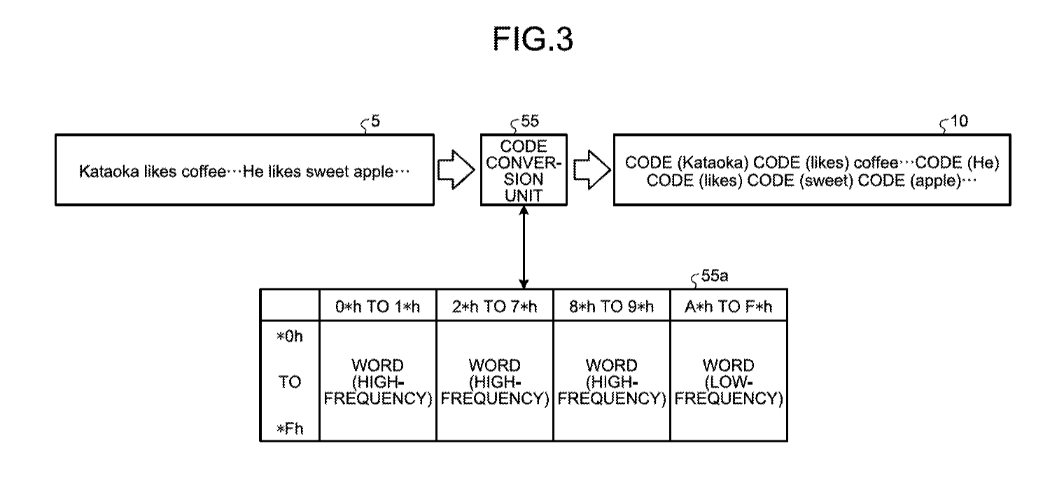

FIG. 3 is a diagram for explaining processing performed by the code conversion unit. As illustrated in FIG. 3, upon receiving text data 5, the code conversion unit 55 generates the compressed text data 10 on the basis of a code allocation table 55a. For example, the code allocation table 55a is a table that associates a word code with a word (high-frequency word and low-frequency word). The high-frequency word is converted to a 1-byte or 2-byte word code. The low-frequency word is converted to a 3-byte word code.

For example, as illustrated in FIG. 3, the first four bits of the word codes of the high-frequency words are included in “00h to 90h”. Moreover, the first four bits of the low-frequency word codes are included in “A0h to F0h”. Consequently, by referring to the first four bits of the word codes, it is possible to differentiate whether the word code is the word code for a high-frequency word or the word code for a low-frequency word. “h” is a code indicating that the number is hexadecimal.

For the sake of simple understanding, word codes corresponding to words “Kataoka, likes, coffee, He, sweet, and apple” are represented as “code (Kataoka), code (likes), code (coffee), code (He), code (sweet), and code (apple)”. For example, when the words “likes, coffee, He, sweet, and apple” are the high-frequency words, the first four bits of the word codes “code (likes), code (coffee), code (He), code (sweet), and code (apple)” are included in “00h to 90h”. When the word “Kataoka” is the low-frequency word, the first four bits of the word code “code (Kataoka)” is included in “A0h to F0h”.

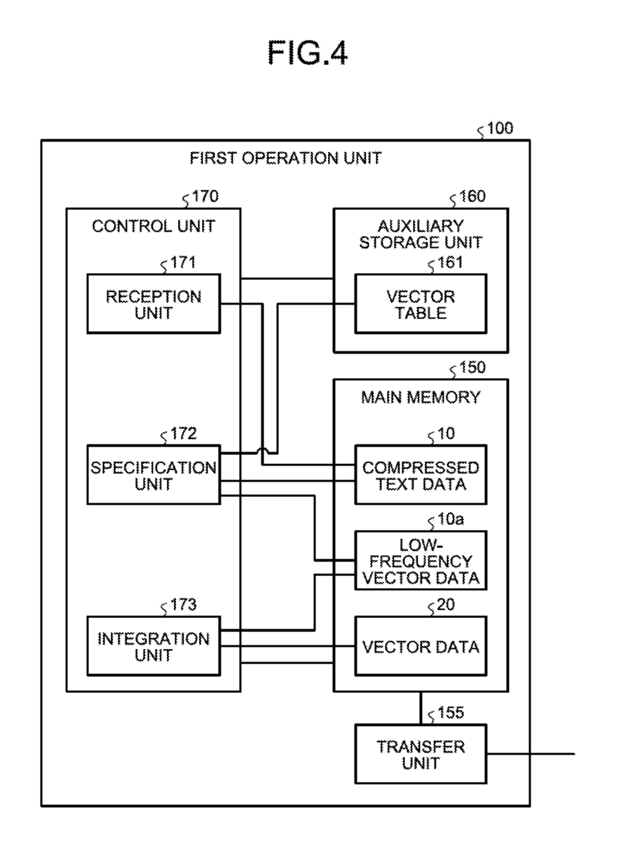

Next, a configuration of the first operation unit 100 described in FIG. 1 will be explained. FIG. 4 is a functional block diagram illustrating a configuration of the first operation unit according to the present embodiment. As illustrated in FIG. 4, the first operation unit 100 includes the main memory 150, the auxiliary storage unit 160, a transfer unit 155, and the control unit 170.

The main memory 150 is a storage device that stores therein the compressed text data 10, the low-frequency vector data 10a, and the vector data 20. For example, the main memory 150 corresponds to a random access memory (RAM) and the like.

The compressed text data 10 is coded (compressed) text data received from the code conversion unit 55. A plurality of coded word codes are included in the compressed text data 10.

The low-frequency vector data 10a includes vector values corresponding to the word codes of the low-frequency words, among the word codes included in the compressed text data 10.

The vector data 20 indicates the vectors of the word codes in the compressed text data 10. As described in FIG. 1, the vector data 20 is a combination of the low-frequency vector data 10a generated by the first operation unit 100 and the high-frequency vector data 10b generated by the second operation unit 200.

The transfer unit 155 is a processing unit that acquires the compressed text data 10 stored in the main memory 150, and that transfers the acquired compressed text data 10 to the second operation unit 200 by DMA. Moreover, the transfer unit 155 receives the high-frequency vector data 10b transferred from the second operation unit 200 by DMA, and stores the received high-frequency vector data 10b in the main memory 150. The illustration of the high-frequency vector data 10b is omitted. The transfer unit 155 is an example of a first transfer unit.

The auxiliary storage unit 160 is a storage device that stores therein the vector table 161. For example, the auxiliary storage unit 160 corresponds to a semiconductor memory element such as a flash memory and a storage device such as a hard disk drive (HDD).

The vector table 161 is a table that stores therein vector values of the word codes of the low-frequency words. FIG. 5 is a diagram illustrating an example of a data configuration of a vector table of the first operation unit. As illustrated in FIG. 5, the vector table 161 associates a low-frequency word code with a vector value. The low-frequency word code is a word code of the low-frequency word. The vector value is a vector value of a word calculated in advance for the word code, on the basis of the technology of Word2Vec and the like. In the present embodiment, the vector value of a certain low-frequency word code is described as vec H. For example, the vector value of the low-frequency word code “Kataoka” is represented as “vec (Kataoka)”. The number of low-frequency words is about a half million words.

Returning to the explanation of FIG. 4. The control unit 170 includes a reception unit 171, a specification unit 172, and an integration unit 173. The control unit 170 is implemented by the CPU, a micro-processing unit (MPU), and the like.

The reception unit 171 is a processing unit that receives the compressed text data 10 from the code conversion unit 55. The reception unit 171 stores the received compressed text data 10 in the main memory 150.

The specification unit 172 specifies the low-frequency word codes among the word codes in the compressed text data 10. For example, the specification unit 172 refers to the first four bits of a word code, and specifies the word code the first four bits of which is one of “A0h to F0h” as a low-frequency word code. The low-frequency word code is a word code the appearance frequency of which is equal to or less than a reference.

The specification unit 172 executes a process of acquiring a vector value corresponding to a low-frequency word code for each of the low-frequency word codes, by comparing the specified low-frequency word code with the vector table 161. The specification unit 172 then generates the low-frequency vector data 10a from the acquired vector values. The specification unit 172 is an example of a first specification unit.

The integration unit 173 is a processing unit that generates the vector data 20 by combining the low-frequency vector data 10a and the high-frequency vector data 10b transferred from the second operation unit 200 by DMA. The integration unit 173 may generate the vector data 20 by arranging the vector values of the word codes in the order of the word codes included in the compressed text data 10. The integration unit 173 may also generate the vector data 20 by setting the vector value obtained by accumulating (summing up) the vector values of the word codes included in the compressed text data 10 as the vector data 20.

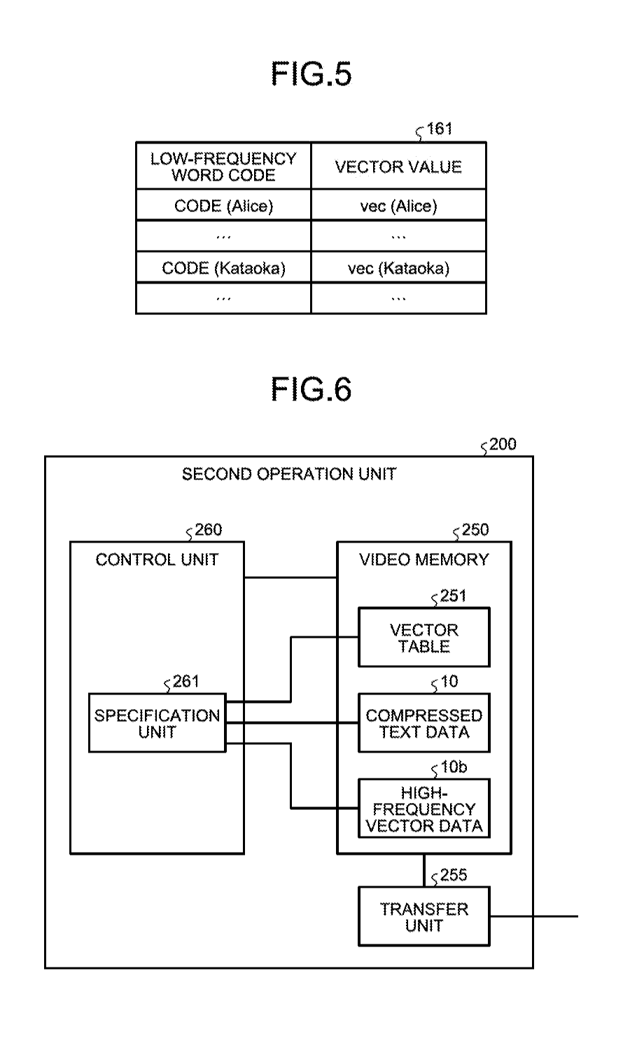

Next, a configuration of the second operation unit 200 described in FIG. 1 will be explained. FIG. 6 is a functional block diagram illustrating a configuration of the second operation unit according to the present embodiment. As illustrated in FIG. 6, the second operation unit 200 includes the video memory 250, a transfer unit 255, and the control unit 260.

The video memory 250 is a storage device that stores therein the vector table 251, the compressed text data 10, and the high-frequency vector data 10b. For example, the video memory 250 corresponds to a RAM and the like.

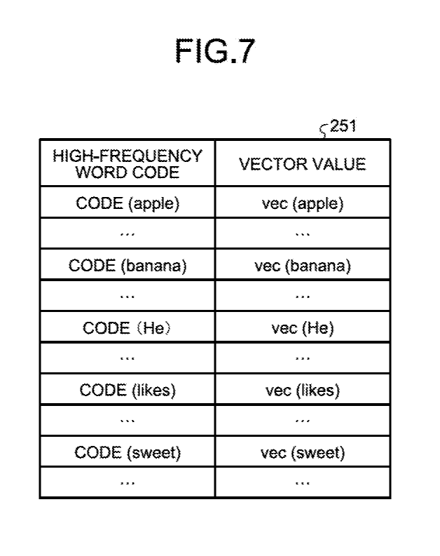

The vector table 251 is a table that stores therein vector values of the word codes of the high-frequency words. FIG. 7 is a diagram illustrating an example of a data configuration of a vector table of the second operation unit. As illustrated in FIG. 7, the vector table 251 associates a high-frequency word code with a vector value. The high-frequency word code is a word code of a high-frequency word. The vector value is a vector value of a word calculated in advance for a word code, on the basis of the technology of Word2Vec and the like. In the present embodiment, the vector value of a certain high-frequency word code is indicated by vec H. For example, the vector value of the high-frequency word code “apple” is represented as “vec (apple)”. The number of high-frequency words is about 4000 words.

The compressed text data 10 is compressed text data transferred from the first operation unit 100 by DMA. The description on the compressed text data 10 is the same as that on the compressed text data 10 described in FIG. 4.

The high-frequency vector data 10b includes the vector values corresponding to the word codes of the high-frequency words, among the word codes included in the compressed text data 10. The high-frequency vector data 10b is an example of a representative vector.

Upon acquiring the compressed text data 10 transferred from the first operation unit 100 by DMA, the transfer unit 255 stores the acquired compressed text data 10 in the video memory 250. Moreover, the transfer unit 255 acquires the high-frequency vector data 10b stored in the video memory 250, and transfers the acquired high-frequency vector data 10b to the first operation unit 100 by DMA. The transfer unit 255 is an example of a reception unit and a second transfer unit.

The control unit 260 includes a specification unit 261. The control unit 260 can be implemented by the GPU and the like.

The specification unit 261 specifies the high-frequency word codes among the word codes in the compressed text data 10. For example, the specification unit 261 refers to the first four bits of a word code, and specifies the word code the first four bits of which is one of “10h to 90h” as a high-frequency word code. The high-frequency word code is a word code the appearance frequency of which exceeds the reference.

The specification unit 261 executes a process of acquiring a vector value corresponding to a high-frequency word code for each of the high-frequency word codes, by comparing the specified high-frequency word code with the vector table 251. The specification unit 261 then generates the high-frequency vector data 10b from the acquired vector values. The specification unit 261 is an example of a second specification unit.

The specification unit 261 may also generate the high-frequency vector data 10b by accumulating the vector values of the high-frequency word codes, or generate the high-frequency vector data 10b by arranging the vector values.

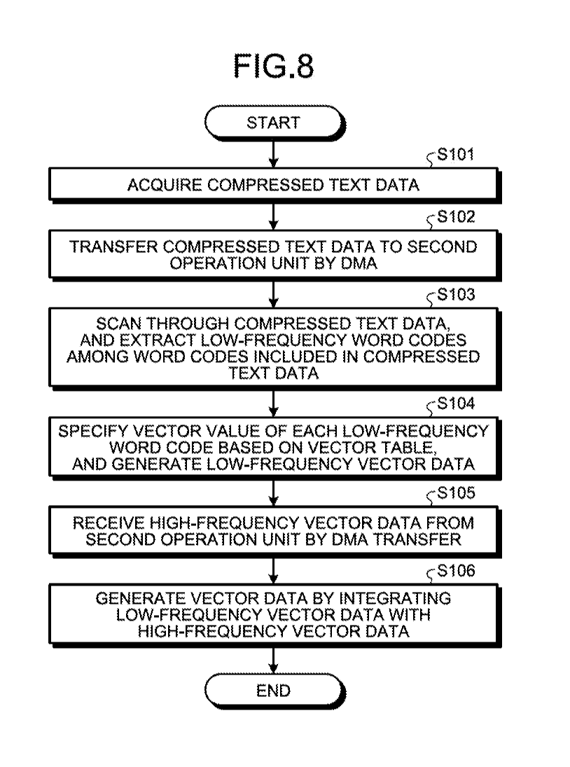

Next, an example of a processing procedure of the first operation unit 100 according to the present embodiment will be described. FIG. 8 is a flowchart illustrating a processing procedure of the first operation unit according to the present embodiment. As illustrated in FIG. 8, the reception unit 171 of the first operation unit 100 acquires the compressed text data 10 (step S101). The transfer unit 155 of the first operation unit 100 transfers the compressed text data 10 to the second operation unit 200 by DMA (step S102).

The specification unit 172 of the first operation unit 100 scans through the compressed text data 10, and extracts the low-frequency word codes among the word codes included in the compressed text data 10 (step S103). The specification unit 172 then specifies the vector value of each of the low-frequency word codes on the basis of the vector table 161, and generates the low-frequency vector data 10a (step S104).

The transfer unit 155 receives the high-frequency vector data 10b from the second operation unit 200 by DMA transfer (step S105). The integration unit 173 of the first operation unit 100 generates the vector data 20 by integrating the low-frequency vector data 10a with the high-frequency vector data 10b (step S106).

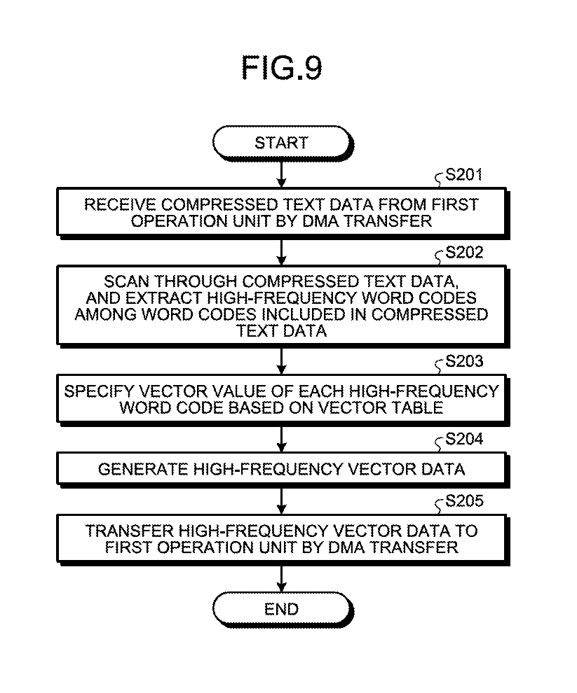

Next, an example of a processing procedure of the second operation unit 200 according to the present embodiment will be described. FIG. 9 is a flowchart illustrating a processing procedure of the second operation unit according to the present embodiment. As illustrated in FIG. 9, the transfer unit 255 of the second operation unit 200 receives the compressed text data 10 from the first operation unit 100 by DMA transfer (step S201).

The specification unit 261 of the second operation unit 200 scans through the compressed text data 10, and extracts the high-frequency word codes among the word codes included in the compressed text data 10 (step S202).

The specification unit 261 specifies the vector value of each of the high-frequency word codes on the basis of the vector table 251 (step S203). The specification unit 261 generates the high-frequency vector data 10b by accumulating the vector values of the high-frequency word codes (S204).

The transfer unit 255 transfers the high-frequency vector data 10b to the first operation unit 100 by DMA (step S205).

Next, effects of the information processing device 50 according to the present embodiment will be described. The first operation unit 100 of the information processing device 50 reads out a part of the vector table 161 to the main memory 150, and generates the low-frequency vector data 10a of the low frequency word codes. By requesting the second operation unit 200 to generate the high-frequency vector data 10b of the high-frequency word codes, the first operation unit 100 can suppress the memory capacity needed for generating vectors for words.

In the second operation unit 200 of the information processing device 50, the high-frequency vector data 10b is generated by making the vector table 251 reside in the video memory 250. Consequently, compared to when the data on the vector table 251 is sequentially read out from an auxiliary storage device, it is possible to accelerate the process of generating the high-frequency vector data 10b of the high-frequency word codes.

To determine whether each of the word codes in the compressed text data 10 is a low-frequency word code or a high-frequency word code, the information processing device 50 according to the present embodiment determines whether the first four bits of the word code is a predetermined bit. Consequently, compared to when all the bits of the word code are referred to determine whether the word code in the compressed text data 10 is a low-frequency word code or a high-frequency word code, it is possible to accelerate the process of determining whether the word code is a low-frequency word code or a high-frequency word code.

Incidentally, in FIG. 1, the generation of vector data is shared between the first operation unit 100 and the second operation unit 200. However, it is not limited thereto. For example, the high-frequency vector table 251 may be made to reside in the main memory 150 of the first operation unit, and high-frequency and low-frequency vector data may be generated only by the first operation unit. Moreover, the compressed text data illustrated in FIG. 4 is directly transferred to the video memory 250 of the second operation unit by DMA, from the main memory 150 of the first operation unit. However, it is not limited thereto. For example, the transfer unit 155 may refer to the vector table 161, remove the low-frequency word codes from the compressed text data 10, and transfer the compressed text data 10 from which the low-frequency word codes are removed, to the video memory 250 of the second operation unit by DMA. In this manner, it is possible to reduce the data amount to be transferred by DMA.

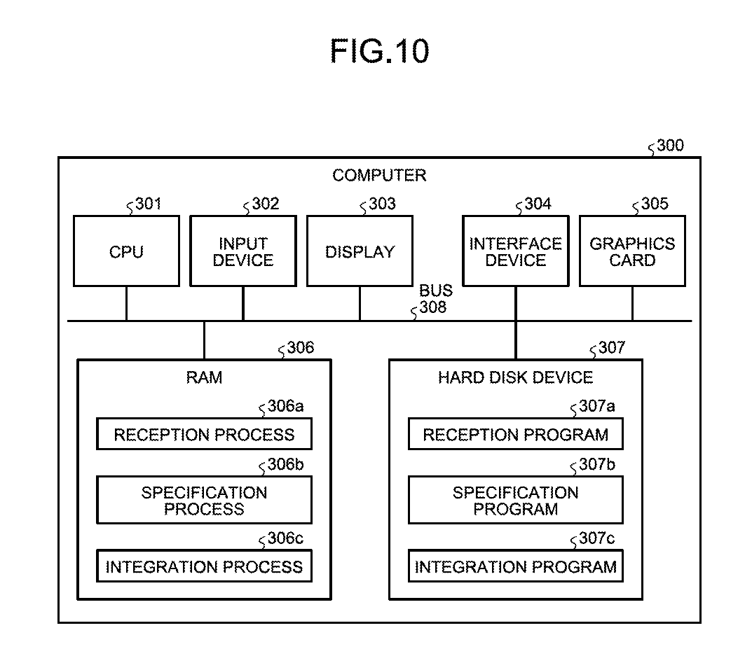

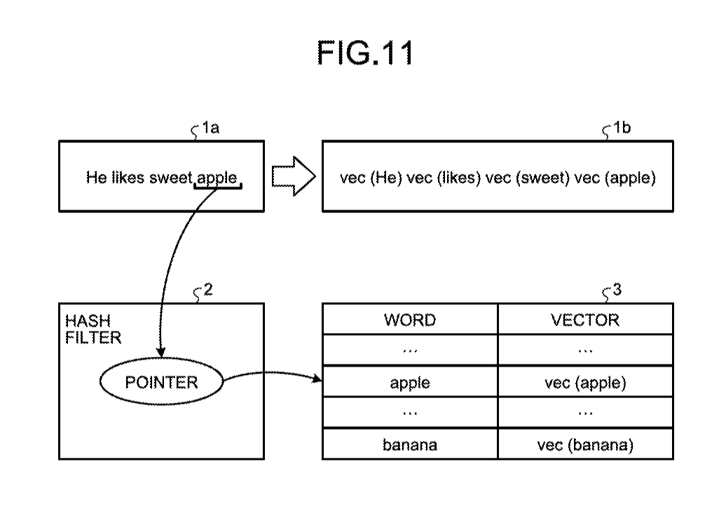

Next, an example of a hardware configuration of a computer that implements the same functions as those of the information processing device 50 in the embodiment described above will be explained. FIG. 10 is a diagram illustrating an example of a hardware configuration of a computer that implements the same functions as those of the information processing device.

As illustrated in FIG. 10, a computer 300 includes a CPU 301 that executes various types of operational processing, an input device 302 that receives data input from a user, and a display 303. The computer 300 includes an interface device 304 that transmits and receives data with a recording device and the like through a wired or wireless network.

The computer 300 includes a graphics card 305. The GPU (not illustrated) of the graphics card 305 executes a specification process. The specification process corresponds to the process executed by the specification unit 261.

Moreover, the computer 300 includes a RAM 306 that temporarily stores therein various types of information, and a hard disk device 307. The various devices 301 to 307 are connected to a bus 308.

The hard disk device 307 includes a reception program 307a, a specification program 307b, and an integration program 307c. The CPU 301 reads out the computer programs 307a to 307c, and develops the computer programs 307a to 307c in the RAM 306.

The reception program 307a functions as a reception process 306a. The specification program 307b functions as a specification process 306b. The integration program 307c functions as an integration process 306c.

The reception process 306a corresponds to the process performed by the reception unit 171. The specification process 306b corresponds to the process performed by the specification unit 172. The integration process 306c corresponds to the process performed by the integration unit 173.

The RAM 306 and the video card included in the graphics card 305 transfer and receive data by DMA transfer.

It is to be understood that the computer programs 307a to 307c need not be stored in the hard disk device 307 from the beginning. For example, the computer programs may be stored in a “portable physical medium” such as a flexible disk (FD), a compact disc-read only memory (CD-ROM), a digital versatile disc (DVD), a magneto-optical disk, and an integrated circuit (IC) card to be inserted into the computer 300. The computer 300 may then read out the computer programs 307a to 307c to execute.

It is possible to suppress the memory capacity needed for summing up the vectors of words and generating vector data.

All examples and conditional language recited herein are intended for pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although the embodiment of the present invention has been described in detail, it should be understood that the various changes, substitutions, and alterations could be made hereto without departing from the spirit and scope of the invention.

What is claimed is:

1. A non-transitory computer readable recording medium having stored therein a program that causes a computer to execute a process comprising:
receiving a plurality of pieces of code information corresponding to a plurality of words included in text data;
specifying a plurality of pieces of code information, an appearance frequency of which exceeds a reference among the pieces of code information being received, based on the pieces of code information;
acquiring a plurality of vectors associated with the pieces of code information being specified, by referring to a storage that stores therein a vector corresponding to a word in association with code information corresponding to the word; and
generating a representative vector representing the vectors being acquired, based on the vectors.

2. The non-transitory computer readable recording medium according to claim 1, wherein the specifying specifies code information, the appearance frequency of which exceeds the reference from the pieces of code information being received, based on information on a specific bit position of the code information.

3. The non-transitory computer readable recording medium according to claim 1 the process further comprising making a high-frequency vector table that indicates a vector of code information, the appearance frequency of which exceeds the reference reside in the storage, by reading out the high-frequency vector table from an auxiliary storage.

4. The non-transitory computer readable recording medium according to claim 1 the process further comprising calculating a vector of code information, the appearance frequency of which is equal to or less than the reference among the pieces of code information, by sequentially reading out data in a low-frequency vector table that indicates a vector of code information, the appearance frequency of which is equal to or less than the reference, from an auxiliary storage that stores therein the low-frequency vector table.

5. A method for generating comprising:
receiving a plurality of pieces of code information corresponding to a plurality of words included in text data, using a processor;
specifying a plurality of pieces of code information, an appearance frequency of which exceeds a reference among the pieces of code information being received, based on the pieces of code information, using the processor;
acquiring a plurality of vectors associated with the pieces of code information being specified, by referring to a storage that stores therein a vector corresponding to a word in association with code information corresponding to the word, using the processor; and
generating a representative vector representing the vectors being acquired, based on the vectors, using the processor.

6. The method for generating according to claim 5, wherein the specifying specifies code information the appearance frequency of which exceeds the reference from the pieces of code information being received, based on information on a specific bit position of the code information.

7. The method for generating according to claim 5, further comprising making a high-frequency vector table that indicates a vector of code information, the appearance frequency of which exceeds the reference reside in the storage, by reading out the high-frequency vector table from an auxiliary storage.

8. The method for generating according to claim 5, further comprising calculating a vector of code information, the appearance frequency of which is equal to or less than the reference among the pieces of code information, by sequentially reading out data in a low-frequency vector table that indicates a vector of code information, the appearance frequency of which is equal to or less than the reference, from an auxiliary storage that stores therein the low-frequency vector table.

9. An information processing device, comprising:
a memory; and
a processor that executes a process comprising:
receiving a plurality of pieces of code information corresponding to a plurality of words included in text data;
specifying a plurality of pieces of code information, an appearance frequency of which exceeds a reference among the pieces of code information being received, based on the pieces of code information;
acquiring a plurality of vectors associated with the pieces of code information being specified, by referring to the memory that stores therein a vector corresponding to a word in association with code information corresponding to the word; and
generating a representative vector representing the vectors being acquired, based on the vectors.

10. The information processing device according to claim 9, wherein the specifying specifies code information, the appearance frequency of which exceeds the reference from the pieces of code information being received, based on information on a specific bit position of the code information.

11. The information processing device according to claim 9, the process further comprising making a high-frequency vector table that indicates a vector of code information, the appearance frequency of which exceeds the reference reside in the memory, by reading out the high-frequency vector table from an auxiliary memory.

12. The information processing device according to claim 9, the process further comprising calculating a vector of code information, the appearance frequency of which is equal to or less than the reference among the pieces of code information, by sequentially reading out data in a low-frequency vector table that indicates a vector of code information, the appearance frequency of which is equal to or less than the reference, from an auxiliary storage that stores therein the low-frequency vector table.
